(19) United States
(12) Patent Application Publication
(10) Pub. No.: US 2025/0259781 A1
(43) Pub. Date: Aug. 14, 2025

(54) Inductor

(71) Applicant: SUMIDA CORPORATION, Tokyo (JP)

(72) Inventors: Tomohiro KAJIYAMA, Natori City (JP); Juichi OKI, Natori City (JP)

(21) Appl. No.: 19/185,612

(22) Filed: Apr. 22, 2025

Related U.S. Application Data
(63) Continuation of application No. PCT/JP2022/041685, filed on Nov. 9, 2022.

(51) Int. Cl. H01F 27/28; H01F 27/29; H01F 27/36

(52) U.S. Cl. CPC H01F 27/2885; H01F 27/29; H01F 27/363

(57) ABSTRACT

An inductor includes a coil, a core that encloses the coil, a pair of terminals conducted with the coil, and a conductor shield that covers a surface of the core. The conductor shield covers at least a part of an upper surface or a side surface of the core. The conductor shield is directly conducted with any one terminal of the pair of terminals. The conductor shield is indirectly conducted with the other terminal via the coil.

### CROSS REFERENCE TO RELATED APPLICATIONS

This application is a continuation of PCT Application No. PCT/JP2022/041685, filed on Nov. 9, 2022, which is expressly incorporated herein by reference in its entirety.

### BACKGROUND

### Technical Field

The present invention relates to an inductor.

### Related Art

Some inductors include a shield for shielding a magnetic field generated by a current flowing through the inductor.

Regarding this type of technology, JP 2019-516246 W discloses an inductor including a core body (115) surrounding a coil (310), a terminal (a lead (120) in JP 2019-516246 W) electrically connected to the coil (310), and a conductor shield (a shielding device (500) in JP 2019-516246 W) that covers at least a part of an outer surface of the core body (115).

In JP 2019-516246 W, the conductor shield is electrically connected to a solder pad (900), the terminal is electrically connected to a solder pad (910) different from the solder pad (900) to which the conductor shield is connected, and the inductor is grounded.

When a current flows through a coil and a magnetic field is generated, an eddy current is generated in a conductor shield. In JP 2019-516246 W, the eddy current is caused to flow through a circuit via a solder pad (900). However, in a case of such a configuration, it is necessary to provide a dedicated circuit for causing the eddy current to flow around the inductor, and there is a problem that design of the circuit is restricted.

The present invention has been made in view of the above-described problems, and provides an inductor that does not impair a degree of freedom in designing a circuit.

### SUMMARY

An inductor of the present invention is an inductor including a coil, a core that encloses the coil, a pair of terminals conducted with the coil, and a conductor shield that covers a surface of the core, in which the conductor shield covers at least a part of an upper surface or a side surface of the core, the conductor shield is directly conducted with any one terminal of the pair of terminals, and the conductor shield is indirectly conducted with the other terminal via the coil.

### Effect of the Invention

According to an inductor of the present invention, since a conductor shield is conducted with a terminal and an eddy current is caused to flow in a circuit to which the terminal is connected, it is not necessary to separately provide a circuit for causing an eddy current to flow. As a result, a degree of freedom in designing an electronic circuit around the inductor can be maintained.

### BRIEF DESCRIPTION OF THE DRAWINGS

The above-described object and other objects, features, and advantages will become more apparent from the following preferred embodiments and accompanying drawings.

FIG. 1 is a perspective view illustrating an example of an inductor according to a first embodiment of the present invention. A brazing material is not illustrated.

FIG. 2 is a perspective view illustrating a coil and a terminal of the inductor according to the first embodiment.

FIGS. 3A and 3B are top views of the inductor according to the first embodiment. A brazing material is not illustrated in FIGS. 3A and 3B. A conductor shield is not illustrated in FIG. 3B.

FIGS. 4A and 4B are front views of the inductor according to the first embodiment. A brazing material is not illustrated in FIG. 4A.

FIG. 5A is a back view of the inductor according to the first embodiment. FIG. 5B is a right side view of the inductor according to the first embodiment.

FIG. 6A is a longitudinal cross-sectional view of the inductor according to the first embodiment when a cross section taken along a one-dot chain line illustrated in FIG. 3A is seen in a direction of arrow VI-VI. FIG. 6B is an enlarged view of a portion X indicated by a dotted line in FIG. 6A.

FIG. 7 is a front view of an inductor according to a second embodiment.

FIG. 8 is a longitudinal sectional view of an inductor according to a third embodiment.

FIG. 9 is a perspective view of an inductor according to a fourth embodiment.

FIG. 10 is a longitudinal cross-sectional view of the inductor according to the fourth embodiment when a cross section taken along a one-dot chain line illustrated in FIG. 9 is seen in a direction of arrow X-X.

FIG. 11A is a top view of the inductor according to the fourth embodiment. FIG. 11B is a back view of the inductor according to the fourth embodiment.

### DETAILED DESCRIPTION

Various components of an inductor of the present invention do not need to be independent from each other, and it is allowed that a plurality of components is formed as one member, one component is formed of a plurality of members, a certain component is a part of another component, a part of a certain component overlap a part of another component and the like. Hereinafter, embodiments of the present invention will be described with reference to the drawings. Note that, in the respective drawings, corresponding components are denoted by the same reference numeral, and redundant description will not be repeated.

Note that, in the present embodiments, as illustrated in the drawing, front-rear, right-left, and up-down directions are defined and described. However, the directions are defined for convenience in order to simply describe a relative relationship of the components, and the direction when manufacturing or using a product on which the present invention is performed is not limited. Sometimes, a center side of the inductor is referred to as an inner side, the opposite side is referred to as an outer side, a direction from a surface of the inductor toward the center is referred to as an inward direction, and the opposite direction is referred to as an outward direction.

A plane referred to in the present invention means a shape physically formed so as to obtain a plane, and it goes without saying that this is not required to be a geometrically perfect plane.

### First Embodiment

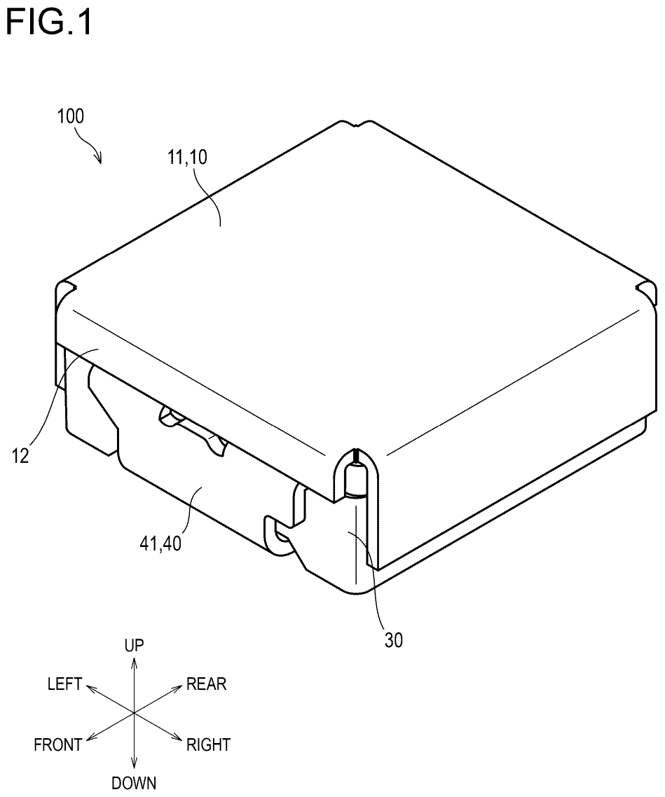

FIG. 1 is a perspective view illustrating an example of an inductor according to a first embodiment of the present invention.

First, an outline of the inductor according to the present embodiment will be described.

An inductor 100 includes a coil 20, a core 30 that encloses the coil 20, a pair of terminals 40 conducted with the coil 20, and a conductor shield 10 that covers a surface of the core 30. The conductor shield 10 covers at least a part of an upper surface or a side surface of the core 30. The conductor shield 10 is directly conducted with any one terminal (a front terminal 41) of the pair of terminals 40. The conductor shield 10 is indirectly conducted with the other terminal (a rear terminal 42) via the coil 20.

Next, the inductor 100 according to the present embodiment will be described in detail.

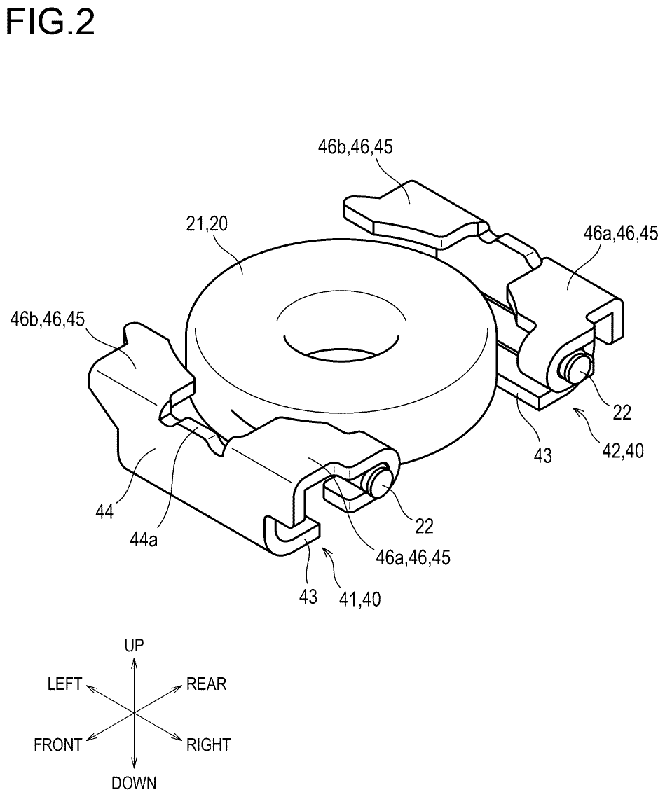

As illustrated in FIG. 2, the coil 20 is obtained by winding a wire material (a coil wire and the like) made of a conductive material such as metal. A portion of the coil 20 in which the wire material is wound is sometimes particularly referred to as a winding portion 21. In FIG. 2, each turn of the wound wire material is not illustrated. The wire material may have a circular cross section or a flat cross section (for example, an ellipse or a horizontally long rectangle). In the present embodiment, a winding axis direction of the coil 20 is the up-down direction, but there is no limitation. The winding axis direction of the coil 20 may be a right-left direction, a front-rear direction and the like.

As illustrated in FIG. 1, the coil 20 is enclosed in the core 30. Here, enclosure is intended to mean arrangement of a substantially entire coil 20 in an envelope volume of the core 30. It is also possible that a part of the coil 20 is not covered with the core 30 and is visible from outside. For example, a lead-out portion 22 (a portion led out from the winding portion 21), which is one end of the wire material of the coil 20, may be arranged outside the core 30. Preferably, an entire winding portion 21 of the coil 20 or an entire coil 20 including the winding portion 21 and the lead-out portion 22 (both ends of the coil wire and the like) is covered with the core 30.

The core 30 is a magnetic member surrounding the coil 20. Examples of a magnetic material forming the core 30 include ferrite and the like, for example. In the present embodiment, the core 30 also enters inside the coil 20 in a radial direction, and forms a closed loop as a whole. More specifically, the core 30 of the present embodiment is integrally formed by placing the coil 20 and the terminals 40 in a mold and pouring a resin containing the magnetic material such as ferrite into the mold. That is, the inductor 100 in the present embodiment is a molded coil.

In place of the present embodiment, as will be described later in a modification, the core 30 may be divided into a plurality of parts.

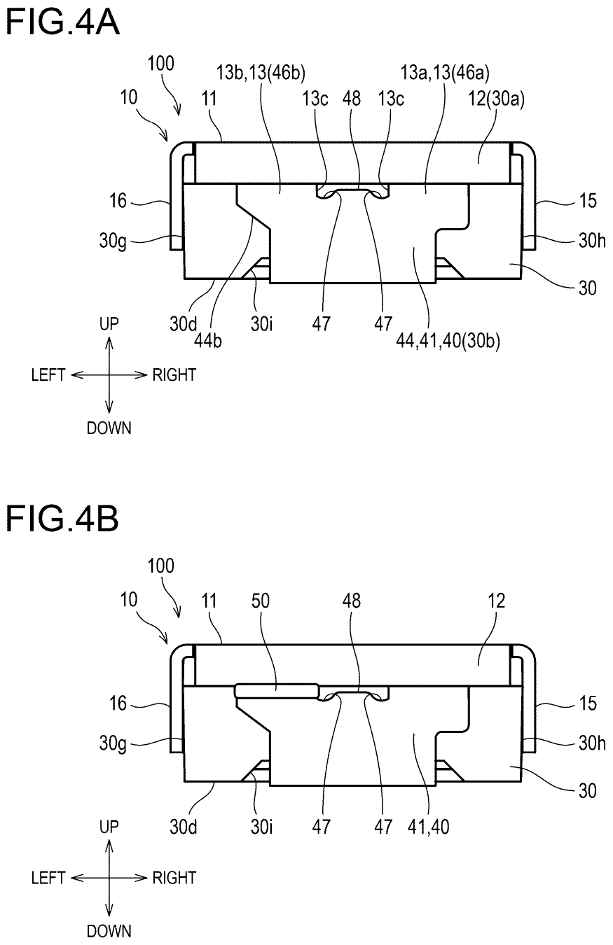

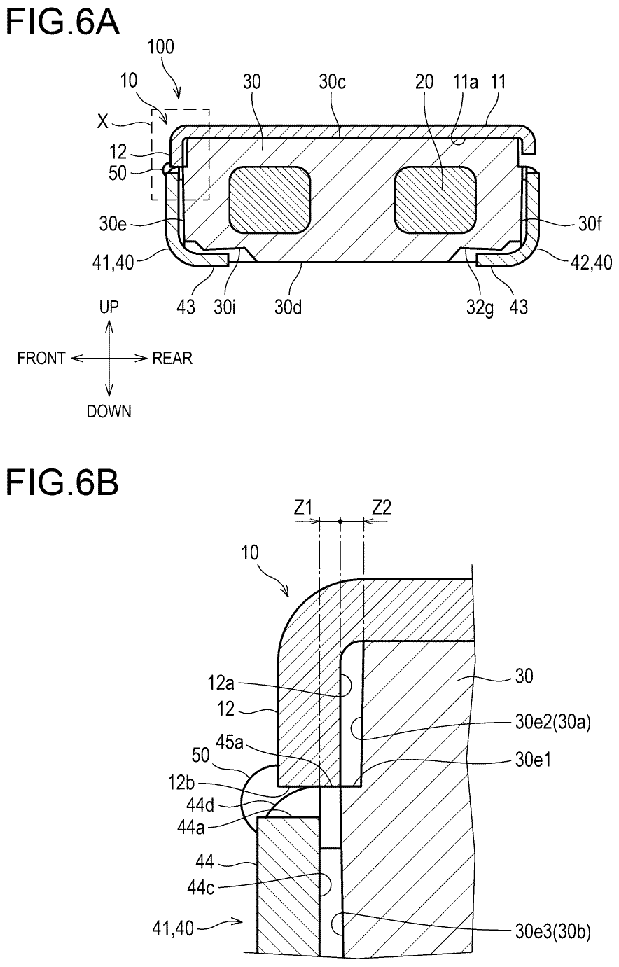

The core 30 of the present embodiment has a substantially rectangular parallelepiped shape as a whole. As illustrated in FIG. 4A or 6A, the core 30 includes an upper surface 30c facing upward, a lower surface 30d facing downward, a front surface 30e facing forward, a back surface 30f facing rearward, a left surface 30g facing leftward, and a right surface 30h facing rightward. In the core 30, areas of the upper surface 30c and the lower surface 30d are larger than areas of the front surface 30e, the back surface 30f, the left surface 30g, and the right surface 30h, and the core 30 has a flat shape as a whole.

The shape of the core 30 is not limited to a rectangular parallelepiped, and may be, for example, a cylinder or a prism including a polygonal bottom surface. The surface forming the core 30 does not need to be a perfect plane, and may be curved or distorted.

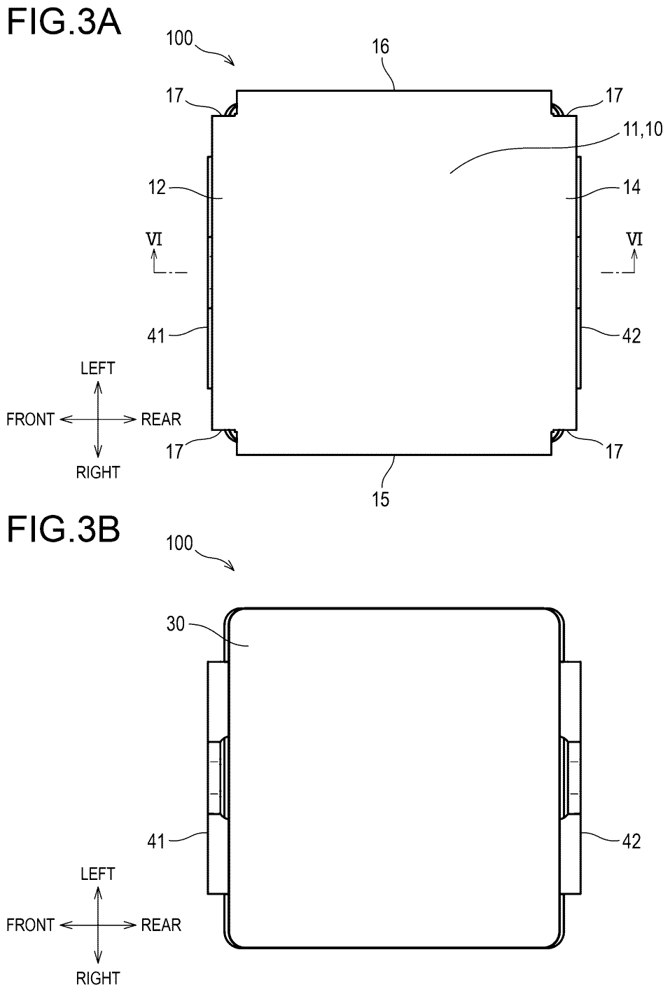

In the present embodiment, as illustrated in FIGS. 3B and 6A, the front surface 30e and the back surface 30f of the core 30 are formed into a one-step stepwise shape. That is, for example, the front surface 30e (refer to FIG. 6A) includes a recessed surface 30e2 formed inside in the front-rear direction, a stair surface 30e1 facing upward, and a projected surface 30e3 formed outside in the front-rear direction as illustrated in FIG. 6B. The back surface 30f similarly includes a recessed surface, a stair surface, and a projected surface.

In place of the present embodiment, the front surface 30e and the back surface 30f may be formed without a step. As illustrated in FIG. 6B, in the present embodiment, the recessed surface 30e2 is slightly inclined outward in the front-rear direction as it is closer to a lower side, and the projected surface 30e3 is slightly inclined inward in the front-rear direction as it is closer to a lower side.

The inductor 100 includes a pair of terminals 40 including the front terminal 41 and the rear terminal 42. Here, the fact that the inductor 100 includes a pair of terminals 40 means that this includes at least the pair of terminals 40 connected to both ends of the coil wire. The inductor 100 may include a terminal other than the pair of terminals. The front terminal 41 and the rear terminal 42 are conducted with one end and the other end of the coil 20, respectively. In other words, in this embodiment, the pair of terminals 40 are input/output terminals or a member composing the input/output terminal (such as a terminal where a coil wire is connected to and twisted around the input/output terminal). Either the front terminal 41 or the rear terminal 42 may be an input terminal, and either may be an output terminal. In other words, each of the pair of terminals 40 in this embodiment is a terminal that constitutes the main circuit in the circuit that the inductor 100 will constitute when it is mounted on the mounting substrate. In this embodiment, each of the pair of terminals 40 is not another terminal such as a ground terminal (earth terminal).

Specifically, as illustrated in FIG. 2, an end (a connecting branch 46a to be described later) of the terminal 40 inserted into the core 30 is bent into a U shape, and grips one end or the other end of the coil 20 to sandwich one end of the coil 20 in the up-down direction. One end of the coil 20 and the terminal 40 are joined to each other by a method such as laser welding, resistance welding and the like, for example. An aspect of conduction between the coil 20 and the terminal 40 is not limited to such direct contact. The coil 20 may be conducted with the terminal 40 via a different member. For example, one end of the wire material forming the coil may be bound to a binding terminal of a member different from the terminal 40, and the binding terminal and the terminal 40 may be connected to each other to electrically connect the coil 20 and the terminal 40 via the binding terminal. The coil 20 and the terminal 40 may be integrally formed of the same member.

As illustrated in FIG. 2, the terminal 40 includes a mounting portion 43 joined to a mounting substrate (not illustrated), an externally arranged portion 44 extending to the side surface of the core 30 (the front surface 30e or the back surface 30f in the present embodiment), and an insertion portion 45 inserted into the core 30. In the present embodiment, an upper end of the terminal 40 is the insertion portion 45, a lower end is the mounting portion 43, and a part between the insertion portion 45 and the mounting portion 43 is the externally arranged portion 44.

The insertion portion 45 corresponding to the upper end of the terminal 40 is inserted into the core 30. As illustrated in FIG. 6B, a terminal upper surface 45a of the insertion portion 45 is flush with the step surface 30e1 on the front surface 30e of the core 30.

As illustrated in FIG. 6A, the terminal 40 projects forward or rearward from the side surface (the front surface 30e or the back surface 30f) of the core 30. That is, in the present embodiment, the front-rear direction is a projecting direction of the terminal 40. As illustrated in FIGS. 1 and 2, a portion of the terminal 40 projecting outward from the core 30 is bent with respect to the insertion portion 45, and a part (the externally arranged portion 44) projecting from the core 30 is arranged along the front surface 30e or the back surface 30f of the core 30.

The terminal 40 is bent between the mounting portion 43 and the externally arranged portion 44. The mounting portion 43, which is the lower end of the terminal 40, is substantially parallel to the lower surface 30d of the core 30. As illustrated in FIG. 6A, a part of the mounting portion 43 is arranged inside a terminal arrangement portion 30i formed to be recessed upward on the lower surface 30d of the core 30. A lower surface of the mounting portion 43 is arranged below the lower surface 30d of the core 30 so that the mounting portion 43 projects from the lower surface 30d of the core 30.

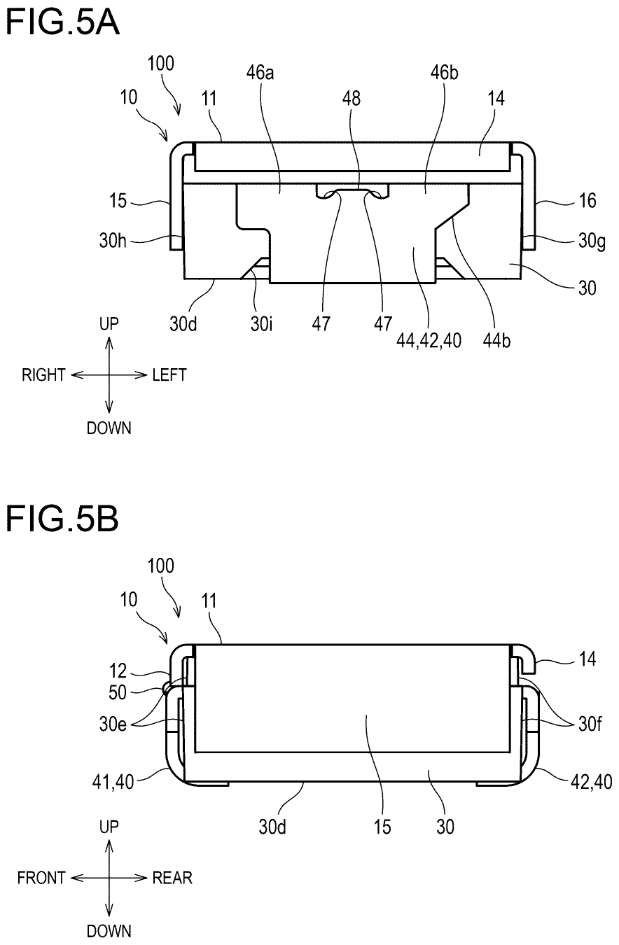

As illustrated in FIG. 2, the upper end of the terminal 40 is branched as described later to form two or more branches 46 (the connecting branch 46a and a non-contact branch 46b described later). As illustrated in FIGS. 4A and 5A, a projection 48 formed into an upwardly projecting shape is provided between the connecting branch 46a and the non-contact branch 46b at a proximal end of the branch 46. The projection 48 projects along the side surface of the core 30 without being bent like the branch 46. A recess 47 recessed downward is formed between the projection 48 and the connecting branch 46a and between the projection 48 and the non-contact branch 46b.

As illustrated in FIG. 4A or 5A, the externally arranged portion 44 has a wider portion on an upper side and a narrower portion narrower than the wider portion on a lower side, so that this has a T shape as a whole. Among the wider portion, a part connected to the non-contact branch 46b to be described later is C-chamfered to form a slope 44b, whereas a part connected to the connecting branch 46a is not C-chamfered and includes a corner.

A width of the externally arranged portion 44 (a width of a narrow portion of the externally arranged portion 44) is preferably equal to or more than ⅓ or equal to or more than half of a lateral width of a second surface or a third surface of the core 30 described later. Since the width of the externally arranged portion 44 is large and the second surface or the third surface is widely covered with the externally arranged portion 44, a leakage magnetic flux is blocked by the externally arranged portion 44.

The inductor 100 is grounded to the mounting substrate such that the mounting portion 43 is in contact with the mounting substrate. The mounting portion 43 and the mounting substrate are joined by soldering or the like to be electrically connected to each other.

In the present embodiment, the terminal is a planar mounting terminal including a flat mounting portion, but there is no limitation. In the terminal 40, the mounting portion 43 may be a pin-shaped terminal.

The conductor shield 10 is made of a conductive thin plate. Examples of the conductive material include metal such as copper. In the present embodiment, the conductor shield 10 covers a part of each of the upper surface 30c, the left surface 30g, the right surface 30h, the front surface 30e, and the back surface 30f of the core 30 as described later. It is possible that the conductor shield 10 covers only a part of the upper surface or only a part of the side surface. As will be described later in the modification, the conductor shield 10 may cover an entire surface of the core 30.

More specifically, in the conductor shield 10, a thin plate made of metal is bent as illustrated in FIG. 1, and covers the upper surface and the side surface of the core 30. The thin plate made of metal is formed into an X shape, and as illustrated in FIG. 3A, a central portion (a cover portion 11 to be described later) of the X shape covers a substantially entire upper surface 30c of the core 30. As illustrated in FIGS. 6A and 6B, a part of the conductor shield 10 extending forward from the upper surface 30c of the core 30 (a front lip 12 to be described later) is bent in the vicinity of a boundary between the upper surface 30c and the front surface 30e of the core 30, and covers the front surface 30e of the core 30. A length of the front lip 12 (dimension directed downward with respect to the upper surface 30c of the core 30) is preferably equal to or more than a distance to the terminal upper surface 45a of the front terminal 41 with reference to the upper surface 30c of the core 30. In other words, the length of the front lip 12 is preferably equal to or more than a distance to the stair surface 30e1 of the front surface 30e with reference to the upper surface 30c of the core 30. In the present embodiment, the length of the front lip 12 is equal to the distance to the terminal upper surface 45a of the front terminal 41 with reference to the upper surface 30c of the core 30, and is equal to the distance to the stair surface 30e1 with reference to the upper surface 30c of the core 30.

As illustrated in FIG. 5B, a portion (a rear lip 14) of the conductor shield 10 extending rearward from the upper surface 30c of the core 30 and bent covers a part of the back surface 30f of the core 30. A length of the rear lip 14 is preferably shorter than the distance to the terminal upper surface 45a of the front terminal 41 with reference to the upper surface 30c of the core 30. As illustrated in FIGS. 4A and 5B, a part of the conductor shield 10 (a right lip 15 or a left lip 16) extending rightward or leftward from the upper surface 30c and bent covers the right surface 30h or the left surface 30g of the core 30. A length of the right lip 15 and the left lip 16 is preferably equal to or more than half, more preferably equal to or more than ⅔ of a thickness of the core 30. FIG. 5B illustrates a right side view of the inductor 100, and a right surface of the inductor 100 is mirror-symmetrical with a left surface.

Since the conductor shield 10 covers the side surface (front surface 30e, back surface 30f, right surface 30h, or left surface 30g) in addition to the upper surface 30c of the core 30, it is possible to shield the magnetic flux leaking from the side surface and to prevent misalignment of the conductor shield 10.

In place of the present embodiment, the conductor shield 10 may include only the cover portion 11 that covers the upper surface 30c (a first surface to be described later) without including the lip (the front lip 12, rear lip 14, right lip 15, and left lip 16). It is possible that the conductor shield 10 does not cover all of the four surfaces, which are the side surfaces, and covers only a part of the side surfaces with the lip.

As illustrated in FIG. 3A, a cutout 17 is provided between the front lip 12, the rear lip 14, the right lip 15, and the left lip 16, and these lips project from the cover portion 11 independently of each other. By providing the cutout 17, the conductor shield 10 can be flexibly deformed to cover the core 30.

In place of the present embodiment, it is possible that the cutout 17 is not provided and portions of the conductor shield 10 covering the respective side surfaces may be continuously connected to each other.

Here, the fact that the conductor shield 10 and the front terminal 41 are directly conducted with each other means that the conductor shield 10 is conducted with the front terminal 41 without the coil 20. In the present embodiment, as illustrated in FIG. 1, the conductor shield 10 (the front lip 12) and the terminal 40 are in contact with each other, and the conductor shield 10 is directly conducted with the terminal 40, but there is no limitation. The conductor shield 10 can be conducted with the front terminal 41 via a member other than the coil 20. For example, it is possible that the conductor shield 10 does not include the front lip 12, and the cover portion 11 of the conductor shield 10 is conducted with the terminal 40 via a conductive wire.

The fact that the conductor shield 10 is indirectly conducted with the rear terminal 42 means that they are conducted with each other via the coil 20. More specifically, the conductor shield 10 and the rear terminal 42 are conducted with each other via the front terminal 41 and the coil 20. In a case where the conductor shield 10 and the rear terminal 42 are conducted with each other via a path without the coil 20, the front terminal 41 and the rear terminal 42 are conducted with each other via two paths of a path including the conductor shield 10 and a path including the coil 20, and the circuit is short-circuited. In contrast, in the present embodiment, as illustrated in FIG. 5A, the conductor shield 10 and the rear terminal 42 are not in contact with each other, so that a short-circuit does not occur.

When a current flows through the inductor 100, the magnetic flux tends to leak out of the core 30. When this leakage magnetic flux is blocked by the conductor shield 10, an eddy current is generated in the conductor shield 10. A line of magnetic force generated by the eddy currents cancels the leakage magnetic flux and suppress an influence on components and the like on the substrate. Since the conductor shield 10 is conducted with the front terminal 41, the generated eddy current can flow to an electric circuit including the front terminal 41, the coil 20, and the rear terminal 42. In other words, the eddy current flows through the main circuit, which is composed of the front terminal 41, the rear terminal 42 and the coil 20.

Therefore, it is not necessary to design an electric circuit including a solder pad (910) for causing the eddy current to flow in addition to a solder pad (900) for connecting the inductor 100 as in JP 2019-516246 W. In other words, it is not necessary to separately provide a circuit branching from the main circuit as a circuit for passing eddy currents (such as a ground circuit). For example, in the present embodiment, inductor 100 does not have any terminals (in particular, a ground terminal) other than the input/output terminals. That is, a degree of freedom in designing the circuit around the inductor 100 can be secured.

The core 30 includes the first surface to which an end face of the coil 20 (the winding portion 21) faces. In other words, the first surface of the core 30 faces the end face of the coil 20 in the winding direction of the coil 20. In the present embodiment, as illustrated in FIGS. 2 and 6A, the end face of the coil 20 faces upward or downward, and the first surface is the upper surface 30c or the lower surface 30d of the core 30. The first surface in the present embodiment is the upper surface 30c of the core 30. In place of the present embodiment, in a case where the end face of the coil 20 faces forward and rearward or rightward and leftward, the first surface is the front surface 30e or the back surface 30f, or the left surface 30g or the right surface 30h.

The conductor shield 10 includes the cover portion 11 that covers at least a part of the first surface (the upper surface 30c). In the present embodiment, as illustrated in FIG. 3A, the cover portion 11 covers the substantially entire upper surface 30c, but since the cutout 17 is provided on the cover portion 11, each corner of the rectangular upper surface 30c is locally exposed from the cover portion 11 in plan view. In place of the present embodiment, the cover portion 11 may cover the entire upper surface 30c, and the cover portion 11 may cover a smaller shape and a part of a dimension of the upper surface 30c. It is preferable that the end face of the coil 20 and the cover portion 11 overlap with each other as seen in the winding axis direction of the coil (the up-down direction in the present embodiment). Furthermore, it is more preferable that the end face of the coil 20 is covered with the cover portion 11 as seen in the winding axis direction of the coil.

When the current flows through the inductor 100, the line of magnetic force is emitted from the end face of the coil 20, and become a main factor of the leakage magnetic flux from the inductor 100. By covering the surface of the core 30 to which the end face of the coil 20 faces, with the conductor shield 10, the line of magnetic force emitted from the end face of the coil 20 to leak out of the core 30 is blocked, and the magnetic flux is excellently prevented from leaking out of the inductor 100.

The core 30 includes the second surface along which one terminal (the front terminal 41) extends. In a case where the cover portion 11 covers the upper surface 30c of the core 30, the second surface is a part of the side surface. Here, the surface of the core 30 along which the terminal 40 extends is more specifically a surface along which the externally arranged portion 44 of the terminal 40 extends. In the present embodiment, the externally arranged portion 44 of the front terminal 41 is arranged along the front surface 30e of the core 30. The second surface in the present embodiment is the front surface 30e of the core 30. The second surface may be another surface (the right surface 30h, left surface 30g, or back surface 30f) of the side surfaces.

A part (the front lip 12) of the conductor shield 10 covers a part of the second surface (the front surface 30e). As illustrated in FIG. 4A, the front lip 12 covers a substantially entire surface of the front surface 30e of the core 30 arranged above the terminal upper surface 45a (refer to FIG. 6B) of the front terminal 41. The front lip 12 may extend below the terminal upper surface 45a of the front terminal 41 to cover a lower side of the front surface 30e of the core 30.

As illustrated in FIG. 6A, the conductor shield 10 (the front lip 12) that covers the second surface (the front surface 30e) and one terminal (the front terminal 41) are in contact with each other. In the present embodiment, as illustrated in FIG. 6B and described later, a surface on an upper side of the front terminal 41 (the terminal upper surface 45a) and the end face 12b of the front lip 12 are in surface contact with each other. As described in a third embodiment, the front terminal 41 and the front lip 12 may be substantially in line contact with each other. The front terminal 41 and the front lip 12 may be in point contact with each other.

Since the conductor shield 10 covers a part of the second surface (the front surface 30e), the magnetic flux leaking from the core 30 can be more excellently shielded.

As illustrated in FIGS. 6A and 6B, an inner surface (the lip inner surface 12a) of a part (the front lip 12) of the conductor shield 10 that covers the second surface (the front surface 30e) of the core 30 is arranged inside an inner surface (a terminal inner surface 44c) along the second surface of one terminal (the front terminal 41) in plan view. More strictly, the lip inner surface 12a is arranged inside the terminal inner surface 44c in the projecting direction (front-rear direction) of the terminal 40. The terminal inner surface 44c along the front surface 30e of the front terminal 41 is an inner surface of the externally arranged portion 44 of the front terminal 41.

The fact of being arranged inside in plan view means being arranged on the center side of the inductor 100 as seen from above. The plan view is not limited to direct visual recognition. For example, it is sufficient that the lip inner surface 12a is arranged inside in the front-rear direction with respect to the terminal inner surface 44c of the front terminal 41 as seen in a vertical cross section as illustrated in FIG. 6B.

As illustrated in FIG. 6B, the terminal 40 is bent between the insertion portion 45 and the externally arranged portion 44, and the outer surface of the bent portion is a curved surface 44d. By arranging the lip inner surface 12a inside the terminal inner surface 44c of the front terminal 41 in the terminal projecting direction, at least a part of the end face 12b (including a side of the rectangular end face 12b) of the front lip 12 is in contact with the upper surface (the terminal upper surface 45a) of the insertion portion 45 of the front terminal 41 as illustrated in FIG. 6B. In the present embodiment, a part on an inner side in the terminal projecting direction of the end face 12b of the front lip 12 is in contact with the horizontal terminal upper surface 45a of the insertion portion 45, and another part on an outer side in the terminal projecting direction of the end face 12b faces the curved surface 44d so as to be separated therefrom. The entire end face 12b of the front lip 12 may be in contact with the terminal upper surface 45a of the insertion portion 45. In this case, an outer surface of the front lip 12 is preferably arranged inside the terminal inner surface 44c of the front terminal 41 in the terminal projecting direction, or arranged flush with the terminal inner surface 44c of the front terminal 41.

In this manner, since the lip inner surface 12a of the front lip 12 and the terminal inner surface 44c of the front terminal 41 are shifted from each other in the front-rear direction, and the front lip 12 and the front terminal 41 are in surface contact with each other on the end face 12b, the front terminal 41 and the conductor shield are excellently conducted with each other. A part of the end face 12b of the front lip 12 and the curved surface 44d of the front terminal 41 face each other, so that a cavity having a shape that is surrounded by the end face 12b of the front lip 12 and the curved surface 44d of the front terminal 41 and is tapered inward in the terminal projecting direction is formed. When solder 50 described later enters the cavity, the conductor shield 10 and the front terminal 41 are firmly connected to each other.

A distance between the lip inner surface 12a and the terminal inner surface 44c of the front terminal 41 (a distance Z1 in FIG. 6B) is preferably equal to or more than ¼ of the thickness (dimension in the front-rear direction) of the front lip 12, or equal to or more than half of the thickness. In other words, the thickness of the front lip 12 is a front-rear width of the end face 12b of the front lip 12. A maximum value of the distance Z1 is preferably equivalent to or smaller than the thickness of the front lip 12. Here, the distance between the lip inner surface 12a and the terminal inner surface 44c is a distance in the terminal projecting direction between a lower end of the lip inner surface 12a and an upper end of the terminal inner surface 44c.

In the present embodiment, as illustrated in FIG. 6B, the lip inner surface 12a is arranged flush with an upper end of the projected surface 30e3 of the front surface 30e of the core 30.

In place of the present embodiment, the conductor shield 10 may be in contact with a portion (such as the curved surface 44d) other than the terminal inner surface 44c of the front terminal 41.

In place of the present embodiment, the lip inner surface 12a and the terminal inner surface 44c of the front terminal 41 may be arranged flush with each other, or the lip inner surface 12a of the front lip 12 may be arranged outside the terminal inner surface 44c of the front terminal 41. In this case, since the conductor shield 10 and the front terminal 41 are substantially in line contact or not in contact with each other, it is preferable to sufficiently secure conduction between the conductor shield 10 and the front terminal 41 by brazing such as soldering.

As illustrated in FIG. 6B, a part (a shield covering portion 30a) covered with the conductor shield 10 of the second surface (the front surface 30e) of the core 30 is formed inside a part (a terminal covering portion 30b) covered with one terminal of the second surface in plan view. The shield covering portion 30a is a region covered with the conductor shield 10 in the front surface 30e of the core 30. In the present embodiment, a substantially entire portion above the stair surface 30e1 of the front surface 30e of the core 30 except for a part exposed from the cutout 17 is the shield covering portion 30a.

A distance between the shield covering portion 30a and the terminal covering portion 30b (Z2 in FIG. 6B) is preferably equivalent to the distance Z1 between the terminal inner surface 44c of the front terminal 41 and the lip inner surface 12a or longer than the distance Z1. Here, equivalent means that the distance Z2 is equal to or more than half and equal to or less than twice of the distance Z1. The distance between the shield covering portion 30a and the terminal covering portion 30b is a distance between a lower end of the shield covering portion 30a and an upper end of the terminal covering portion 30b in the terminal projecting direction.

In the present embodiment, as illustrated in FIGS. 6A and 6B, an entire portion above the stair surface 30e1 (the recessed surface 30e2) in the front surface 30e of the core 30 is arranged inside an entire portion below the stair surface 30e1 (the projecting surface 30e3) in the front surface 30e of the core 30 in the terminal projecting direction. In place of the present embodiment, an aspect may be adopted in which only the shield covering portion 30a of the front surface 30e is recessed rearward, and the recessed shield covering portion 30a is arranged inside the terminal covering portion 30b in the terminal projecting direction. Conversely, it is possible that only the terminal covering portion 30b of the front surface 30e of the core 30 projects forward, and the projected terminal covering portion 30b is arranged outside the shield covering portion 30a in the terminal projecting direction. On the front surface 30e of the core 30, a portion not covered with the front lip 12 may be outside or inside the terminal covering portion 30b in the terminal projecting direction.

Since the shield covering portion 30a and the terminal covering portion 30b are misaligned on the second surface in this manner, the front lip 12 is easily arranged inside the front terminal 41 in plan view. In other words, the end face 12b of the front lip 12 easily comes into surface contact with the front terminal 41, and the conduction between the conductor shield 10 and the front terminal 41 is easily kept excellently.

In the present embodiment, as illustrated in FIG. 6A, an inner surface of the cover portion 11 (a cover inner surface 11a) is arranged substantially parallel to the upper surface 30c of the core 30.

It is possible that an insulating material is arranged or not by application or the like on a part of the surface of the core 30 covered with the conductor shield 10 (a part of the upper surface and the side surface) or a substantially entire area of the inner surface of the conductor shield 10. In a case where the insulating material is arranged between the core 30 and the conductor shield 10, the cover inner surface 11a of the cover portion 11 and the upper surface 30c of the core 30 are arranged along with the insulating material interposed therebetween. In a case where the insulating material is not arranged, the surface center and a peripheral edge of the cover inner surface 11a of the cover portion 11 are in direct contact with the upper surface 30c of the core 30.

In the inductor disclosed in JP 2019-516246 W, it is necessary to apply an insulating material to an inner surface of a conductor shield or a surface of a core (115) in order to shield the inductor from noise from the solder pad (910) to which the conductor shield is connected. In the present embodiment, since the noise does not flow into the conductor shield 10, it is not necessary to apply the insulating material between the core 30 and the conductor shield 10. Therefore, a step of applying the insulating material is omitted, and the inductor 100 can be manufactured easily at a low cost.

In the present embodiment, the conductor shield 10 and one terminal (the front terminal 41) are joined to each other by welding or brazing. Examples of the welding include fusion welding with a laser or a gas. Examples of the brazing include soldering by solder or the like and brazing by other metal brazing. In the present embodiment, the conductor shield 10 and the front terminal 41 are brazed to each other by the solder 50.

As described below, the conductor shield 10 may be brazed or welded to both the branches 46 of the front terminal 41 described below, or may be brazed or welded to only one branch. By joining the conductor shield 10 to the front terminal 41 by welding or brazing, the conductor shield 10 is prevented from being separated from the front terminal 41, and the conduction between the conductor shield 10 and the front terminal 41 is secured.

In place of the present embodiment, it is possible that the conductor shield 10 and the front terminal 41 are not joined to each other by brazing or welding. For example, the conductor shield 10 is allowed to abut the front terminal 41 to secure the conduction. The conductor shield 10 and the front terminal 41 may be fixed with an adhesive.

As illustrated in FIG. 2, one terminal (the front terminal 41) includes two or more branches formed by branching of one end. In the present embodiment, the front terminal 41 includes two branches 46. Each branch 46 is formed so as to project upward from the externally arranged portion 44, in other words, the branch 46 is formed by branching of the terminal 40 at an upper portion of the externally arranged portion 44. That is, in the front terminal 41, the connecting branch 46a to be described later is formed from an upper right portion of the externally arranged portion 44, and the non-contact branch 46b to be described later is formed from an upper left portion of the externally arranged portion 44. The branch 46 is not limited to such a shape, and for example, the branch 46 may be formed by branching from the middle of the externally arranged portion 44, or may be formed by branching from the middle of the insertion portion 45. As illustrated in FIG. 4A, it is preferable that a proximal end (a base portion where the terminal 40 branches) of the branch 46 (the connecting branch 46a and non-contact branch 46b) is located outside the core 30 as in the present embodiment.

As illustrated in FIG. 2, a part of each of branches 46 is inserted into the core 30. In the present embodiment, a substantially entire branch 46 is inserted into the core 30, and a part on the proximal end side of the branch 46 is arranged outside the core 30. In the present embodiment, the branch 46 is the same as the insertion portion 45.

In the present embodiment, the other terminal (the rear terminal 42) also branches to form the branch 46 similarly to the front terminal 41, and a part of the branch 46 is inserted into the core 30. The front terminal 41 and the rear terminal 42 have mirror-symmetrical shapes.

As illustrated in FIG. 2, one of the branches (the connecting branch 46a) is directly conducted with the coil 20, and at least one of the other branches (non-contact branch 46b) is indirectly conducted with the coil 20 via the one of the branches (the connecting branch 46a). Here, the fact that the non-contact branch 46b is indirectly conducted with the coil 20 means that they are conducted with each other via the connecting branch 46a. In other words, the entire non-contact branch 46b is not in contact with the coil 20. In the present embodiment, the non-contact branch 46b and the coil 20 are conducted with each other via the connecting branch 46a and the externally arranged portion 44.

As illustrated in FIG. 4B, the other branch (the non-contact branch 46b illustrated in FIG. 4A) and the conductor shield 10 are in contact with and joined to each other by brazing or welding. In the present embodiment, the non-contact branch 46b and the conductor shield 10 are brazed to each other by the solder 50. The solder 50 enters a gap between the front terminal 41 and the conductor shield 10, and is also arranged between the end face 12b of the front lip 12 and the curved surface 44d of the front terminal 41 as illustrated in FIG. 6B, for example.

In the present embodiment, the connecting branch 46a is in contact with the conductor shield 10, but it is also possible that this is not in contact therewith. It is preferable that the connecting branch 46a and the conductor shield 10 are not joined. In the present embodiment, the solder 50 is not arranged between contact portions 13 and 13 described later, but this may also be arranged.

By joining the non-contact branch 46b that is not directly conducted with the coil 20 to the conductor shield 10 in this manner, it is not necessary to join the connecting branch 46a that is directly conducted with the coil 20 to the conductor shield 10. As a result, a thermal load on the connecting branch 46a can be minimized.

In place of the present embodiment, an aspect in which the connecting branch 46a and the conductor shield 10 are joined to each other and the non-contact branch 46b and the conductor shield 10 are not joined may be adopted.

### Second Embodiment

The present embodiment is an embodiment different from the first embodiment only in a manner of joining a conductor shield 10 to a front terminal 41, and the conductor shield 10, a coil 20, a core 30, and a terminal 40 of an inductor 100 in the present embodiment are common to those in the first embodiment.

In the present embodiment, the conductor shield 10 and one terminal (a front terminal 41) are joined to each other by welding or brazing.

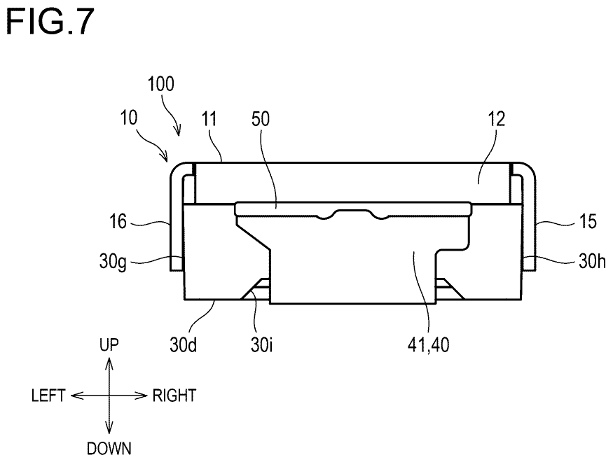

Also in the present embodiment, as in the first embodiment, one terminal (the front terminal 41) includes two or more branches 46 formed by branching of one end, and a part of each of the branches 46 is inserted into the core 30. As illustrated in FIG. 7, each of the two or more branches 46 (a connecting branch 46a and a non-contact branch 46b illustrated in FIG. 4A) and the conductor shield 10 are joined to each other. In a case where the front terminal 41 and the conductor shield 10 are brazed to each other, solder 50 for joining the connecting branch 46a to the conductor shield 10 and solder 50 for joining the non-contact branch 46b to the conductor shield 10 may be continuous or divided as described later.

In this manner, since each of the two or more branches 46 is joined to the conductor shield 10, the front terminal 41 and the conductor shield 10 are firmly connected.

In the present embodiment, as in the first embodiment illustrated in FIG. 4A, one terminal (the front terminal 41) is in contact with the conductor shield 10 at each of two or more contact portions 13 separated from each other. In other words, in one contact portion 13a, the connecting branch 46a is in contact with the conductor shield 10, and in another contact portion (in this embodiment, in which the terminal 40 has two contact portions 13, it refers to the other contact portion 13b), the non-contact branch 46b is in contact with the conductor shield 10. The contact portion 13 refers to a portion of the front terminal 41 in contact with the conductor shield 10 and a part in the vicinity thereof, and in the present embodiment, refers to a part of a terminal upper surface 45a of the front terminal 41 and a portion in the vicinity thereof. In other words, the contact portion 13 in the present embodiment is a part on a proximal end side of the branch 46 (a front end of an insertion portion 45 and a bent portion between the insertion portion 45 and an externally arranged portion 44).

As illustrated in FIG. 7, a brazing material (solder 50) is arranged between the one contact portion 13a (refer to FIG. 4A) and the other contact portion 13b (refer to FIG. 4A). That is, a part of the solder 50 is arranged between facing end faces 13c and 13c (refer to FIG. 4A) where the contact portions 13 face each other. In other words, as illustrated in FIG. 4A, a cavity surrounded by the one contact portion 13a, an upper end face 44a (refer to FIG. 2 or 6B) of the front terminal 41 forming a recess 47 and a projection 48, and the other contact portion 13b is formed on the terminal 40, and the solder 50 enters and accumulates in the cavity as illustrated in FIG. 7. More specifically, the solder 50 is in contact with each of the upper end face 44a of the front terminal 41 (refer to FIG. 6B), an end face 12b of a front lip 12, and the facing end faces 13c of the contact portions 13 (refer to FIG. 4A).

In the present embodiment, as illustrated in FIGS. 4A and 7, the solder 50 joins the upper end face 44a (refer to FIG. 6B) of the front terminal 41 to the end face 12b of the front lip 12. That is, the one contact portion 13a, the other contact portion 13b, and a portion between the one contact portion 13a and the other contact portion 13b in one terminal (the front terminal 41) are all joined to the conductor shield 10 by the brazing material (solder 50). The solder 50 that joins the one contact portion 13a, the other contact portion 13b, and a portion between the one contact portion 13a and the other contact portion 13b in one terminal (the front terminal 41) to the conductor shield 10 are arranged continuously.

Since the solder 50 is arranged between the contact portions 13 and 13, the solder 50 can be accumulated on the upper end face 44a of the front terminal 41, particularly in the recess 47, and the liquid solder 50 can be prevented from flowing down when the front terminal 41 and the conductor shield 10 are brazed to each other.

The solder 50 is in contact with not only the curved surface 44d of the front terminal 41 but also the upper end face 44a on which the recess 47 and the projection 48 are formed, so that the solder 50 is in contact with the front terminal 41 in various directions. This prevents the solder 50 from being peeled off from the front terminal 41.

In the present embodiment, a cross section (a cross section orthogonal to an extending direction of the solder, that is, right-left direction) of the solder 50 arranged between the contact portions 13a and 13b has a larger dimension and a different shape than the cross section of the solder 50 arranged on an upper edge of the contact portion 13. That is, a thickness (dimension in a front-rear direction) of the solder 50 arranged between the contact portions 13a and 13b is thicker than the thickness of the solder 50 arranged in the vicinity of the contact portion 13. Therefore, even in a case where a thermal load over time is applied, the solder 50 arranged between the contact portions 13a and 13b is less likely to be cracked, and joining between the conductor shield 10 and the terminal 40 can be maintained.

### Third Embodiment

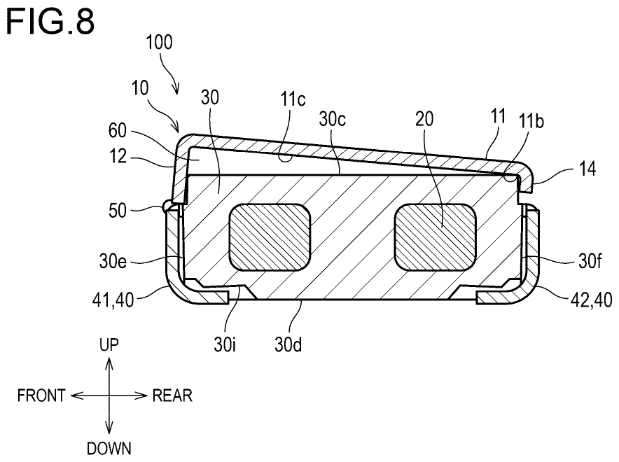

The present embodiment illustrated in FIG. 8 is different from the first or second embodiment only in a manner of placing a conductor shield 10. The conductor shield 10, a coil 20, a core 30, a terminal 40, and solder 50 of an inductor 100 in the present embodiment are common to those of the inductor 100 in the first or second embodiment, and a shape in a top view is substantially common to that of the inductor 100 in the first embodiment illustrated in FIG. 3A. FIG. 8 is a longitudinal sectional view of the inductor 100 according to a third embodiment. A position and a viewing direction of the longitudinal section illustrated in FIG. 8 are common to arrow VI-VI illustrated in FIG. 3A according to the first embodiment.

In the present embodiment, as illustrated in FIG. 8, a part (a core contact portion 11b) of a cover portion 11 is in contact with the core 30, and a hollow portion 60 is provided between another part (separation portion 11c) of the cover portion 11 and a part of a first surface (upper surface 30c). More specifically, in the present embodiment, a length of a front lip 12 is longer than a distance to a terminal upper surface 45a of a front terminal 41 with reference to an upper surface 30c of the core 30. Therefore, as a result of abutment between the front lip 12 and the front terminal 41, a part on a second surface side in a cover inner surface 11a (refer to FIG. 6A) and a part of the upper surface 30c of the core 30 are separated from each other. At that time, one end on an inner side in a terminal projecting direction of an end face 12b of the front lip 12 (for example, an inner side in the terminal projecting direction of a rectangular end face 12b) is in contact with the front terminal 41. The front lip 12 is in contact with the terminal upper surface 45a or a curved surface 44d of the front terminal 41. Note that, in FIG. 8, a height of the hollow portion 60 is exaggerated. A maximum height of the hollow portion 60 (dimension to a highest point of the hollow portion 60 with reference to the upper surface 30c of the core 30) is preferably smaller than a thickness of the conductor shield 10 (cover portion 11).

The core contact portion 11b in contact with the core 30 is a part on a rear side of the cover portion 11, and the separation portion 11c is a part on a front side (second surface side) than the core contact portion 11b of the cover portion 11. In the present embodiment, the core contact portion 11b is in contact with a corner, which is a boundary between the upper surface 30c and a back surface 30f of the core 30.

In the present embodiment, in addition to the core contact portion 11b, the conductor shield 10 is in contact with a lower end of an inner surface of a rear lip 14 and a part of a lip inner surface 12a (refer to FIG. 6B) of the front lip 12. The lower end of the inner surface of the rear lip 14 is in contact with the back surface 30f of the core 30, and the lip inner surface 12a (refer to FIG. 6B) of the front lip 12 is in contact with a corner, which is a boundary between the upper surface 30c and a front surface 30e of the core 30.

The hollow portion 60 is a space defined by the separation portion 11c, the lip inner surface 12a of the front lip 12, the first surface (upper surface 30c), and inner surfaces of a right lip 15 and a left lip 16.

In place of the present embodiment, the hollow portion 60 may be provided without the cover inner surface 11a being in contact with the core 30. For example, an aspect may be adopted in which the cover inner surface 11a is not in contact with the corner, which is the boundary between the upper surface 30c and the back surface 30f of the core 30, and the lower end of the rear lip 14 is in contact with the core 30.

Since there is the hollow portion 60 between the core 30 and the cover portion 11, the core 30 and the cover portion 11 can be insulated from each other by air in the hollow portion 60 without applying an insulating material to a surface of the core 30 covered with the cover portion 11 or the cover inner surface 11a.

The cover portion 11 is downwardly inclined so as to approach the first surface (the upper surface 30c) from another part of the cover portion 11 (the separation portion 11c) toward the part of the cover portion 11 (the core contact portion 11b). Downward inclination does not necessarily mean the downward inclination in an actual vertical relationship, but means the inclination approaching the first surface with reference to the first surface. In other words, the cover portion 11 intersects with the first surface. A thickness (dimension in an up-down direction) of the hollow portion 60 gradually increases toward the second surface (the front surface 30e) and gradually decreases toward the back surface 30f of the core 30.

As described above, by making the length of the front lip 12 longer than the distance from the upper surface 30c of the core 30 to the front terminal 41, and arranging the conductor shield 10 such that the cover portion 11 is downwardly inclined, the front lip 12 can surely contact the front terminal 41.

### Fourth Embodiment

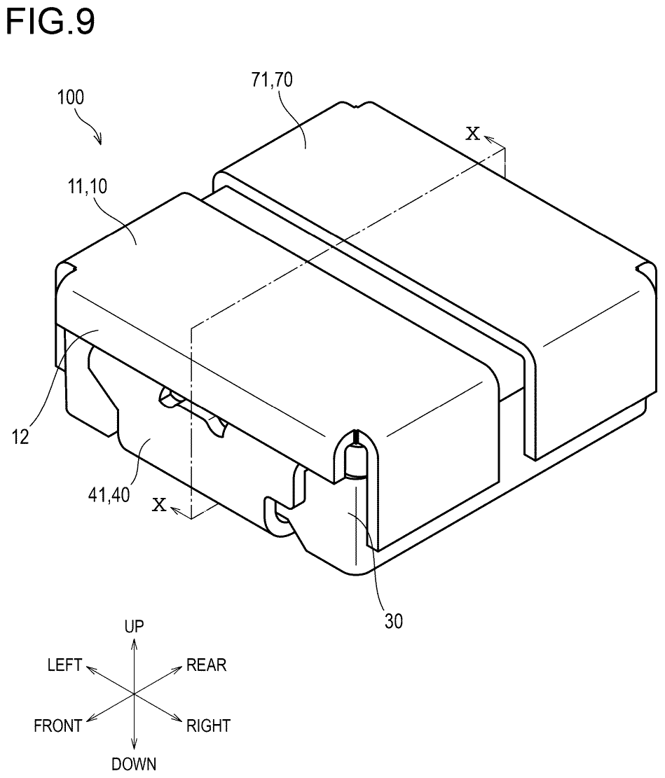

As illustrated in FIG. 9, the present embodiment is different from the first, second, or third embodiment in that not only a conductor shield 10 but also a second conductor shield 70 is provided. A coil 20, a core 30, a terminal 40, and solder 50 in an inductor 100 of the present embodiment are common to those of the first, second, or third embodiment.

The inductor 100 according to the present embodiment includes a second conductor shield (the second conductor shield 70). The second conductor shield 70 covers at least a part of an upper surface or a side surface of the core. The second conductor shield 70 and another terminal (a rear terminal 42) are directly conducted with each other, and the second conductor shield 70 and one terminal (a front terminal 41) are indirectly conducted with each other via the coil 20. The fact that the second conductor shield 70 and the rear terminal 42 are directly conducted with each other means that the second conductor shield 70 is conducted with the rear terminal 42 without the coil 20. The second conductor shield 70 can be conducted with the rear terminal 42 via a member other than the coil 20 (for example, a conductive wire and the like).

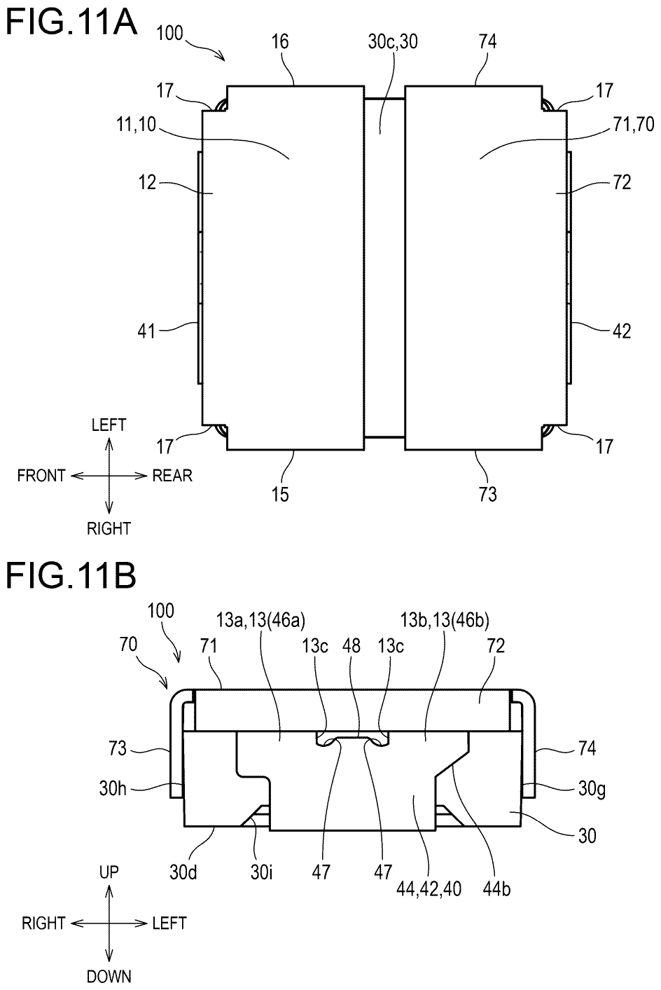

As illustrated in FIGS. 11A and 11B, the second conductor shield 70 includes a rear lip 72 that covers a part of a third surface (a back surface 30f of the core 30 in the present embodiment) to which an externally arranged portion 44 of the rear terminal 42 extends, a right lip 73 that covers a right surface 30h of the core 30, and a left lip 74 that covers a left surface 30g of the core 30.

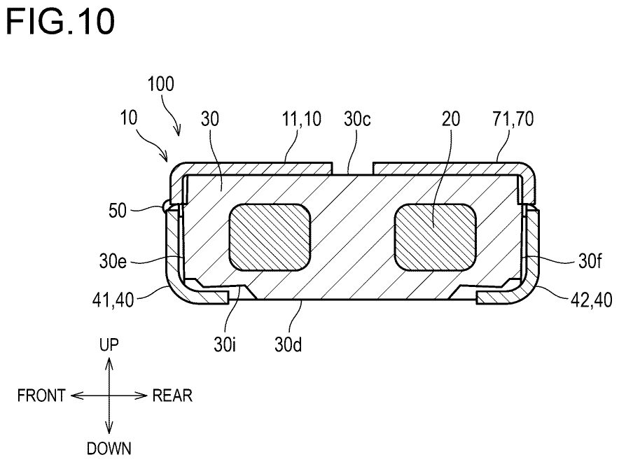

As illustrated in FIGS. 10 and 11B, the rear lip 72 of the second conductor shield 70 is in contact with the rear terminal 42. Similarly to the front lip 12 of the conductor shield 10, the rear lip 72 is in surface contact with the rear terminal 42 at a lower end face. Alternatively, a contact portion between the rear lip 72 and the rear terminal 42 may be substantially a line or a point.

In the present embodiment, as illustrated in FIG. 11A, the conductor shield 10 and the second conductor shield 70 cover only a part of a first surface (an upper surface 30c of the core 30). Specifically, the conductor shield 10 covers a front half of the upper surface 30c and does not cover a rear half of the upper surface 30c. The second conductor shield 70 covers the rear half of the upper surface 30c and does not cover the front half. More specifically, the conductor shield 10 and the second conductor shield 70 have the same shape and dimension, and areas covered with the conductor shield 10 and the second conductor shield 70 on the upper surface 30c are approximately the same.

In place of the present embodiment, a dimension of a cover portion 11 of the conductor shield 10 and a dimension of a second cover 71 that covers the first surface of the second conductor shield 70 may be larger or smaller. Either the conductor shield 10 or the second conductor shield 70 may cover the surface center of the upper surface 30c, and either the conductor shield 10 or the second conductor shield 70 may overlap an end face of the coil 20 as seen in a winding axis direction of the coil 20.

In the present embodiment, as described above, the conductor shield 10 covers a front side of the upper surface 30c of the core 30 and the second conductor shield 70 covers a rear side, but there is no limitation. For example, the conductor shield 10 may cover a right side of the upper surface 30c of the core 30, and the second conductor shield 70 may cover a left side.

As illustrated in FIG. 10, in the present embodiment, the second cover 71 and the first surface (the upper surface 30c) are substantially parallel to each other, and a substantially entire inner surface of the second cover 71 is in contact with the upper surface 30c. A part of the second cover 71 and the core 30 may be in contact with each other, and a hollow portion may be provided between another part of the second cover 71 and a part of the upper surface 30c. In a case where the hollow portion is provided, one end on the front side of the second cover 71 is in contact with the upper surface 30c of the core 30, and the second cover 71 is downwardly inclined with respect to the first surface (the upper surface 30c) from one end on the third surface (the back surface 30f) side toward the other end on the second surface (the front surface 30e) side.

In the present embodiment, as illustrated in FIG. 10, a substantially entire cover portion 11 of the conductor shield 10 is in contact with the front half of the upper surface 30c of the core 30. In a case where the hollow portion is provided between the conductor shield 10 and the core 30, one end on the rear side of the conductor shield 10 is in contact with the upper surface 30c of the core 30.

The second conductor shield 70 and the rear terminal 42 are joined by welding or brazing. As an aspect of joining, similarly to the joining between the conductor shield 10 and the front terminal 41, it is possible that the rear terminal 42 includes two or more branches 46, and each of the two or more branches 46 is joined to the second conductor shield 70, or only one branch 46 is joined to the conductor shield 10.

Similarly to an arrangement relationship between the conductor shield 10 and the front terminal 41, it is preferable that the inner surface of the rear lip 72 that covers the back surface 30f, which is the third surface, is arranged inside the inner surface of the rear terminal 42 along the back surface 30f in plan view. It is preferable that a part of the third surface covered with the second conductor shield 70 is formed inside another part of the third surface covered with the rear terminal 42 in plan view. As a result, the second conductor shield 70 and the rear terminal 42 are brought into surface contact with each other and are conducted excellently.

The conductor shield 10 and the second conductor shield 70 are separated from each other. A sufficient creeping distance is maintained so that the conductor shield 10 and the second conductor shield 70 are not directly conducted. In the present embodiment, the end face facing the rear of the conductor shield 10 and the end face facing the front of the second conductor shield 70 face each other so as to be separated from each other. The conductor shield 10 and the second conductor shield 70 are arranged such that their respective end faces face each other, and a distance between the conductor shield 10 and the second conductor shield 70 is substantially uniform.

In the present embodiment, as illustrated in FIG. 11B, the length of the rear lip 72 can be made longer than that of the first, second, and third embodiments. As a result, the leakage magnetic flux can be blocked in a wider area of the back surface 30f of the core 30.

Note that, the present invention is not limited to the above-described embodiments, and includes various modifications, improvements and the like as long as the object of the present invention is achieved.

Following modifications can be appropriately combined.

In the above-described embodiment, the conductor shield 10 covers a part of the surface of the core 30, but there is no limitation, and this may cover the entire surface of the core 30. For example, the conductor shield 10 may have a rectangular parallelepiped shape including a cavity that can enclose the entire core 30, in which only the mounting portion 43 is exposed to the outside of the conductor shield 10. In this case, a sufficient creeping distance is maintained so that the conductor shield 10 and the rear terminal 42 are not directly conducted without the coil 20.

It is possible that the front lip 12 is not in contact with the front terminal 41. In this case, the front lip 12 is conducted with the front terminal 41 via a separate member. For example, the front lip 12 and the front terminal 41 are joined by the solder 50, and the front lip 12 is conducted with the front terminal 41 via the solder 50.

In the above-described embodiment, the terminal 40 including the branch 46 has been exemplified, but there is no limitation. The terminal 40 may be in contact with the conductor shield 10 at one contact portion 13 without including the branch 46. In a case where the front terminal 41 is joined to the conductor shield 10 at one contact portion, the front terminal 41 may be joined to the conductor shield 10 in the entire contact portion 13, and the front terminal 41 may be joined to the conductor shield 10 in a part of the contact portion 13 and not joined to the conductor shield 10 in another part of the contact portion 13.

In the above-described embodiment, the aspect in which the core 30 is integrally formed has been described, but there is no limitation, and the core 30 may include a plurality of members. For example, the core may be divided into an upper core and a lower core with the step surface 30e1 (refer to FIG. 6B) provided in the core 30 to be described later as a boundary. Alternatively, the core 30 may be a pot core. For example, a core that covers the peripheral surface and one end face of the coil 20, a columnar core inserted through the center of the coil 20, and a plate-shaped core that covers the other end face of the coil 20 may be combined to form the core 30. In this case, for example, the conductor shield 10 may be arranged so as to cover an upper side of the plate-shaped core.

The above embodiment includes the following technical ideas.

(1) An inductor including: a coil; a core that encloses the coil; a pair of terminals conducted with the coil; and a conductor shield that covers a surface of the core, in which
the conductor shield covers at least a part of an upper surface or a side surface of the core,
the conductor shield is directly conducted with any one terminal of the pair of terminals, and
the conductor shield is indirectly conducted with the other terminal via the coil.

(2) The inductor according to (1), in which
the core includes a first surface to which an end face of the coil faces, and
the conductor shield includes a cover portion that covers at least a part of the first surface.

(3) The inductor according to (1) or (2), in which
the core includes a second surface along which the one terminal extends,
a part of the conductor shield covers a part of the second surface, and
the conductor shield that covers the second surface is in contact with the one terminal.

(4) The inductor according to (3), in which
an inner surface of a part of the conductor shield that covers the second surface is arranged inside an inner surface along the second surface of the one terminal.

(5) The inductor according to (4), in which
a part covered with the conductor shield in the second surface is arranged inside another part covered with the one terminal in the second surface.

(6) The inductor according to any one of (2) to (5), in which
a part of the cover portion is in contact with the core, and
a hollow portion is provided between another part of the cover portion and a part of the first surface.

(7) The inductor according to (6), in which
the cover portion is downwardly inclined so as to approach the first surface from the another part of the cover portion toward the part of the cover portion.

(8) The inductor according to any one of (1) to (7), in which
the conductor shield is joined to the one terminal by welding or brazing.

(9) The inductor according to (8), in which
the one terminal includes two or more branches formed by branching of one end,
a part of each of the branches is inserted into the core,
one of the branches is directly conducted with the coil,
at least one of the other branches is indirectly conducted with the coil via the one of the branches, and
the one of the other branches are in contact with and joined to the conductor shield.

(10) The inductor according to (8), in which
the one terminal includes two or more branches formed by branching of one end,
a part of each of the branches is inserted into the core, and
each of the two or more branches is joined to the conductor shield.

(11) The inductor according to (10), in which
the one terminal is in contact with the conductor shield at each of two or more contact portions separated from each other,
a brazing material is arranged between one of the contact portions and another of the contact portions, and all of the one contact portion, the another contact portion, and a portion between the one contact portion and the another contact portion of the one terminal are joined to the conductor shield with the brazing material.

(12) The inductor according to (1) to (11), including:
a second conductor shield, in which
the second conductor shield covers at least a part of an upper surface or a side surface of the core;
the second conductor shield is directly conducted with the other terminal;
the second conductor shield is indirectly conducted with the one terminal via the coil; and
the conductor shield and the second conductor shield are separated from each other.

(13) An inductor, in which a length of a part of the conductor shield that covers the second surface is equal to or more than a distance to the one terminal with reference to the first surface.

(14) An inductor, in which at least a part of a partial end face that covers the second surface of the conductor shield is in surface contact with the one terminal.

(15) The inductor according to (14), in which the terminal projects outward from the core, a part of an inner side of the end face is in surface contact with the one terminal in a projecting direction of the terminal, and another part of an outer side in the projecting direction faces a curved surface of the one terminal that is bent.

(16) An inductor, in which a distance between an inner surface of a part that covers the second surface in the conductor shield and an inner surface of the one terminal is equal to or more than ¼ of a thickness of the part of the conductor shield that covers the second surface, and is equal to or less than the thickness of the part of the conductor shield that covers the second surface.

(17) The inductor according to (15), in which a brazing material that joins the conductor shield and the one terminal is arranged between an end face of the conductor shield and the curved surface of the one terminal.

(18) The inductor according to (9), in which the one branch is a non-joined portion of the conductor shield and the one terminal.

(19) The inductor according to (11), in which the one contact portion, the another contact portion, and a brazing material that joins the one contact portion and the another contact portion in the one terminal are continuous.

What is claimed is:

1. An inductor comprising:
a coil;
a core that encloses the coil;
a pair of terminals conducted with the coil; and
a conductor shield that covers a surface of the core, wherein
the conductor shield covers at least a part of an upper surface or a side surface of the core,
the conductor shield is directly conducted with any one terminal of the pair of terminals, and
the conductor shield is indirectly conducted with the other terminal via the coil.

2. The inductor according to claim 1, wherein
the core includes a first surface to which an end face of the coil faces, and
the conductor shield includes a cover portion that covers at least a part of the first surface.

3. The inductor according to claim 1, wherein
the core includes a second surface along which the one terminal extends,
a part of the conductor shield covers a part of the second surface, and
the conductor shield that covers the second surface is in contact with the one terminal.

4. The inductor according to claim 3, wherein
an inner surface of a part of the conductor shield that covers the second surface is arranged inside an inner surface along the second surface of the one terminal in plan view.

5. The inductor according to claim 4, wherein
a part covered with the conductor shield in the second surface is arranged inside another part covered with the one terminal in the second surface in plan view.

6. The inductor according to claim 2, wherein
a part of the cover portion is in contact with the core, and
a hollow portion is provided between another part of the cover portion and a part of the first surface.

7. The inductor according to claim 6, wherein
the cover portion is downwardly inclined so as to approach the first surface from the another part of the cover portion toward the part of the cover portion.

8. The inductor according to claim 1, wherein
the conductor shield is joined to the one terminal by welding or brazing.

9. The inductor according to claim 8, wherein
the one terminal includes two or more branches formed by branching of one end,
a part of each of the branches is inserted into the core,
one of the branches is directly conducted with the coil,
at least one of the other branches is indirectly conducted with the coil via the one of the branches, and
the one of the other branches are in contact with and joined to the conductor shield.

10. The inductor according to claim 8, wherein
the one terminal includes two or more branches formed by branching of one end,
a part of each of the branches is inserted into the core, and
each of the two or more branches is joined to the conductor shield.

11. The inductor according to claim 10, wherein
the one terminal is in contact with the conductor shield at each of two or more contact portions separated from each other, and
a brazing material is arranged between one of the contact portions and another of the contact portions, and all of the one contact portion, the another contact portion, and a portion between the one contact portion and the another contact portion of the one terminal are joined to the conductor shield with the brazing material.

12. The inductor according to claim 1, further comprising:
a second conductor shield, wherein
the second conductor shield covers at least a part of an upper surface or a side surface of the core;
the second conductor shield is directly conducted with the other terminal;
the second conductor shield is indirectly conducted with the one terminal via the coil; and
the conductor shield and the second conductor shield are separated from each other.
